(19) United States
(12) Patent Application Publication
(10) Pub. No.: US 2026/0092603 A1
(43) Pub. Date: Apr. 2, 2026

(54) PISTON INTENDED FOR A FLUID MACHINE AND PROVIDED WITH A SYSTEM FOR PRESSING SEALS, FLUID MACHINE COMPRISING SUCH A PISTON

(71) Applicant: L'Air Liquide, Societe Anonyme pour l'Etude et l’Exploitation des Procedes Georges Claude, Paris (FR)

(72) Inventors: Youssef ABDO, Paris (FR); Gaetan COLEIRO, Paris (FR); Guillaume PETITPAS, Paris (FR); Loic RIOS, Paris (FR)

(21) Appl. No.: 19/341,752

(22) Filed: Sep. 26, 2025

(30) Foreign Application Priority Data
Sep. 30, 2024 (FR) FR2410445

(51) Int. Cl. F04B 53/14; F03G 7/06; F04B 37/08

(52) U.S. Cl. CPC F04B 53/143; F03G 7/06114; F04B 37/08

(57) ABSTRACT

Piston for a fluid machine, the piston being configured to be mounted at least in part inside a liner of the machine with a relative back- and forth movement with respect to the liner, the piston extending in a main direction and comprising a head, which has a first end of the piston, and a shaft, which has a second end of the piston, the first end of the piston being configured to delimit, with the liner of the machine, a fluid expansion and/or compression chamber, the shaft comprising a lateral wall which is provided with at least one annular groove defined between a first crenelation and a second crenelation, the at least one annular groove being equipped with at least one gasket seal configured to cooperate in a sealed manner with a lateral wall of the liner of the machine, the at least one gasket seal being provided with a through-orifice configured to allow a stream of fluid to flow from the expansion and/or compression chamber towards the second end of the piston, wherein the at least one gasket seal comprises at least one cavity separate from the through-orifice, the cavity being configured to accommodate a pressing system for pressing the gasket seal against the first crenelation and against the second crenelation, in the main direction of the piston.

### CROSS REFERENCE TO RELATED APPLICATIONS

This application claims the benefit of priority under 35 U.S.C. § 119 (a) and (b) to French patent application No, FR2410445, filed Sep. 30, 2024, which is herein incorporated by reference in its entirety.

### FIELD OF THE INVENTION

The invention relates to a piston configured for a fluid machine and provided with a system for pressing seals. The seals in question are non-tight seals comprising at least one orifice for the flow of fluid.

The invention also relates to a fluid machine comprising such a piston. The fluid machine may be a pump or a compressor. The fluid in question may be in the cryogenic state.

### BACKGROUND OF THE INVENTION

A piston for a fluid machine is configured to be mounted at least in part inside a liner of the machine, with a relative back- and-forth movement with respect to the liner.

The piston extends in a main direction and comprises a head, which has a first end of the piston, and a shaft, which has a second end of the piston. The first end and the second end of the piston are defined according to the main direction.

The first end of the piston is configured to form, with the liner of the machine, a fluid expansion and/or compression chamber.

The shaft comprises a lateral wall which is provided with at least one annular groove defined between a first crenelation and a second crenelation.

In particular, the annular groove is equipped with at least one gasket seal configured to cooperate with a lateral wall of the liner of the machine. The at least one gasket seal is provided with a through-orifice configured to allow a stream of fluid to flow from the expansion and/or compression chamber towards the second end of the piston.

The gasket seal or seals primarily ensure the compression chamber is sealed without impeding the relative movement of the piston with respect to the liner. In other words, the gasket seal or seals allow the piston to move with respect to the liner with virtually no friction.

Moreover, the gasket seal or seals ensure the proper operation of the fluid machine and greatly contribute to meeting the specifications of the latter, in particular the flow rate pumped.

Lastly, the seal or seals make it possible to reduce leaks and BOG (Boil Off Gas).

BOG is an irreversibly vaporized fluid that cannot be re-liquefied without external cold exchange or extraction of work. BOG may result from the generation of entropy by heat inputs (imperfect insulation quality) into the expansion chamber or may be caused by friction and/or Joules-Thomson isenthalpic expansion due to leaks.

To perform the various functions described above, a sufficient number of gasket seals is required which depends on the performance of each seal, the pressure involved, and other factors, such as the fluid itself. Moreover, the gasket seals are required to have good mechanical integrity for optimal operation of the fluid machine at high pressures and extremely low temperatures.

In most cases, a pair of gasket seals is provided in each groove: a first gasket seal in contact with a first crenelation of the groove, and a second gasket seal in contact with a second crenelation of the groove. Starting from the piston head, the first gasket seal precedes the second gasket seal.

The first gasket seal is equipped with a first through-orifice. The second gasket seal is equipped with a second through-orifice. Moreover, the first gasket seal and the second gasket seal are arranged in the groove in such a way that their respective through-orifices are angularly offset from each other about the main axis of the piston.

Thus, the stream of fluid originating from the compression chamber follows a leakage path which passes through the first orifice of the first gasket seal, then goes along the interface between the two gasket seals, before passing through the second orifice of the second gasket seal.

When an axial clearance (i.e. a clearance in the main direction of the piston) forms between the first gasket seal and the first crenelation, the stream of fluid originating from the compression chamber no longer necessarily passes through the first orifice of the first gasket seal. A portion of the stream bypasses the first through-orifice and the second through-orifice to flow into the gap provided between the seals and the lateral wall of the piston and/or into the gap provided between the seals and the lateral wall of the liner.

The change in the leakage path represents a loss of sealing and a deterioration in the performance of the machine.

Thus, a need has arisen to develop new pistons in which the stream originating from the compression chamber passes essentially only through the through-orifices provided to that end, without bypassing the gasket seals.

### SUMMARY OF THE INVENTION

In an effort to overcome the deficiencies of the prior art discussed, supra, a first aspect of the invention relates to a piston which is otherwise in accordance with the generic definition thereof given in the above preamble.

According to this first aspect of the invention, the at least one seal comprises at least one cavity separate from the through-orifice, the cavity being configured to accommodate a system for pressing the gasket seal against the first crenelation and against the second crenelation in the main direction of the piston.

Thus, the invention opens up the possibility of introducing into the gasket seal a system for pressing the latter in the main direction of the piston. This pressing eliminates the risk of an axial clearance developing between the gasket seal and the first crenelation on the one hand, and between the gasket seal and the second crenelation on the other.

Other embodiments of the piston comprise the features below:
the at least one gasket seal comprises, in a single piece, two lateral lips: a first lip arranged facing the first crenelation, and a second lip arranged facing the second crenelation,
the lips define between them the cavity configured to accommodate the pressing system,
two separate gasket seals are arranged facing each other in the at least one groove: a first seal facing the first crenelation and a second seal facing the second crenelation,
the two seals have facing faces, each provided with a notch,
the respective notches of the seals are aligned to form the cavity configured to accommodate the pressing system,
the pressing system is of the mechanical and/or fluidic type,
the pressing system is in the form of an insert arranged permanently in the cavity,
the pressing system comprises a mass of fluid which originates from the compression chamber and is stored in the cavity,
the mass of fluid is configured to press, in the main direction of the piston, the first lip against the first crenelation and the second lip against the second crenelation,
the insert is configured to press, in the main direction of the piston, the first lip against the first crenelation and the second lip against the second crenelation,
the mass of fluid is configured to press, in the main direction of the piston, the first seal against the first crenelation and the second seal against the second crenelation,
the insert is configured to press, in the main direction of the piston, the first seal against the first crenelation, and the second seal against the second crenelation,
the insert and the at least one seal consist respectively of materials having different coefficients of thermal expansion, the coefficient of thermal expansion of the insert being greater than the coefficient of thermal expansion of the seal.

According to a second aspect, the invention relates to a fluid machine, and in particular a cryogenic fluid machine, for example a pump for cryogenic fluid such as hydrogen, comprising a liner and a piston according to any one of the preceding embodiments, the piston being inserted at least in part inside the liner so as to form, with the liner, a fluid expansion and/or compression chamber, the piston and the liner being configured so as to be movable one with respect to the other in a relative back- and-forth movement.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Other particular features and advantages will become apparent from reading the following description, provided with reference to the following figures, in which:

FIG. 1 is a sectional view illustrating a first embodiment of the fluid machine according to the invention, the machine comprising a liner, a piston, a set of gasket seal(s), and a removable system of crenelation(s) along the piston, the gasket seals each being provided with a cavity and a pressing system, the piston comprising a single gasket seal between two crenelations.

FIG. 2 is a partial sectional view illustrating another example of the machine according to the first embodiment, the system of crenelation(s) being fixed relative to the piston.

FIG. 3 is a partial sectional view illustrating another example of the fluid machine according to the first embodiment, the seal having a C shape which delimits a cavity containing the pressing system, the cavity facing the liner.

FIG. 4 is a partial sectional view illustrating another example of the fluid machine according to the first embodiment, the seal having a C-shaped form which delimits a cavity illustrated without the pressing system, the cavity facing the liner.

FIG. 5 is a partial sectional view illustrating another example of the fluid machine according to the first embodiment, the seal having a C shape, the seal and the pressing system facing the piston.

FIG. 6 is a partial sectional view illustrating another example of the fluid machine according to the first embodiment, the seal having a Z-shaped profile which forms two cavities configured to receive the pressing system.

FIG. 7 is a partial sectional view illustrating an example of the fluid machine according to a second embodiment, the piston comprising, between two consecutive crenelations, two separate seals each having a recess, the respective recesses of the seals forming the cavity configured to receive the pressing system, the cavity facing the liner.

FIG. 8 is a partial sectional view illustrating another example of the machine according to the second embodiment, the cavity facing the piston.

FIG. 9 is a partial sectional view illustrating another example of the machine according to the second embodiment, the cavity being closed and located in a middle position between the liner and the piston.

FIG. 10 is a partial sectional view illustrating a third embodiment of the machine according to the invention, the piston comprising, between two consecutive crenelations, two separate seals separated by a gap configured to receive the C-shaped pressing system.

FIG. 11 is a partial sectional view illustrating another example of the machine according to the third embodiment, the pressing system comprising a series of V-shaped inserts.

### DETAILED DESCRIPTION OF THE INVENTION

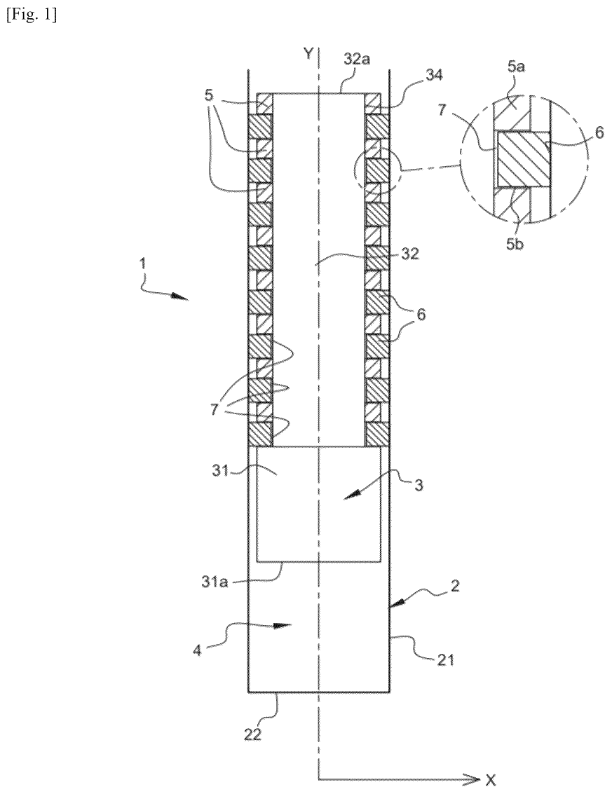

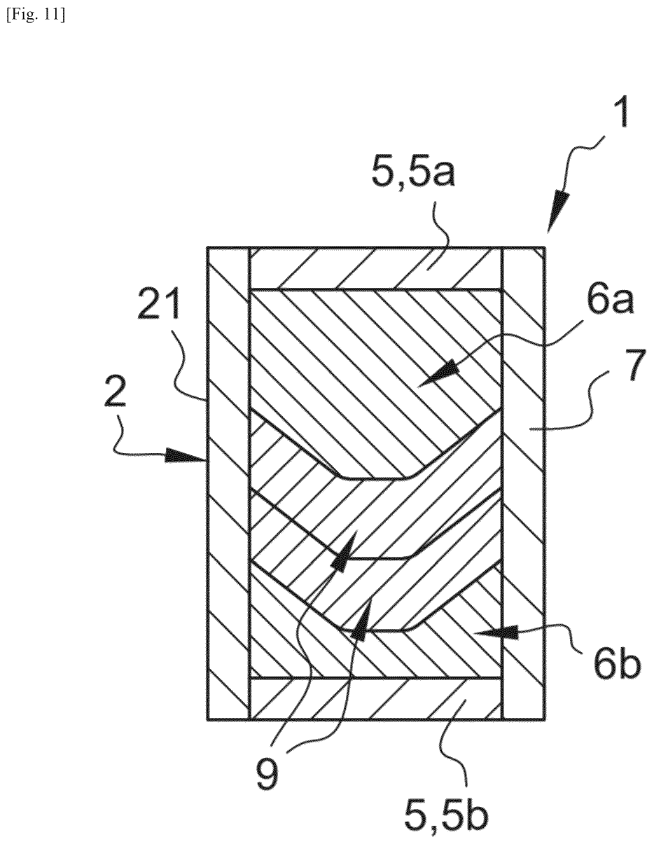

As illustrated in [FIG. 1] to [FIG. 11], the invention relates to a fluid machine 1, and in particular a cryogenic fluid machine. The fluid machine 1 may be a pump or a compressor for transferring a fluid. The fluid in question may be cryogenic at a temperature of less than 150° C. It may be hydrogen.

With reference to [FIG. 1], the fluid machine 1 extends along a main axis Y, also referred to as the “longitudinal axis” or “longitudinal direction” or else “main direction”.

The fluid machine 1 also has a transverse axis X which is perpendicular to the main axis Y. The transverse axis X is also referred to hereinafter as the “radial axis” or “radial direction”.

The fluid machine 1 comprises a liner 2 and a piston 3, which is arranged at least in part inside the liner 2. In particular, the piston 3 and the liner 2 are configured to be mounted so as to be movable one with respect to the other in a relative back- and-forth movement in the main direction Y.

The piston 3 and the liner 2 form a compression and/or expansion chamber 4 configured to receive and deliver a fluid for expansion and/or compression in a cycle comprising a phase for the intake and a phase for the delivery of the fluid in the compression and/or expansion chamber 4.

In other words, the volume of the compression and/or expansion chamber 4 varies depending on the relative position of the piston 3 with respect to the liner 2, and depending on the phase (intake or delivery) of the cycle of intake and delivery of the fluid in the chamber 4.

In order to move one relative to the other, the piston 3 or the liner 2 may be connected to a drive member (not illustrated).

More specifically, the piston 3 comprises a head 31, which is inserted inside the liner 2, and a shaft 32, which is connected to the head 31. With the shaft 32, the head 31 forms a shoulder. The shaft 32 is connected to a rod (not illustrated), which is configured to be arranged outside the liner 2, and may be actuated by the drive member.

In particular, the head 31 of the piston 3 has a first end 31a. The shaft 32 of the piston 3 has a second end 32a opposite the first end 31a.

The liner 2 comprises a lateral wall 21 and a bottom 22 which form a recess in which the head 31 of the piston 3 is inserted. Thus, the bottom 22 and the lateral wall 21 of the liner 2, and the first end 31a of the piston 3, delimit the expansion and/or compression chamber 4.

Furthermore, the lateral wall 21 and/or the bottom 22 of the liner 2 are provided with at least one inlet orifice and at least one outlet orifice. These orifices communicate with the compression and/or expansion chamber 4.

Still with reference to [FIG. 1], the machine 1 comprises a system of crenelation(s) 5 arranged on a lateral wall 34 of the piston 3, along the main direction Y. In particular, the system of crenelation(s) is arranged on a portion of the lateral wall 34 located in a region facing the shaft 32 of the piston 3.

Advantageously, the system of crenelation(s) 5 extends in an O shape around the lateral wall 34 of the piston 3, i.e. the system of crenelation(s) 5 is closed around the lateral wall 34 of the head 31 of the piston 3, in a plane perpendicular to the main direction Y.

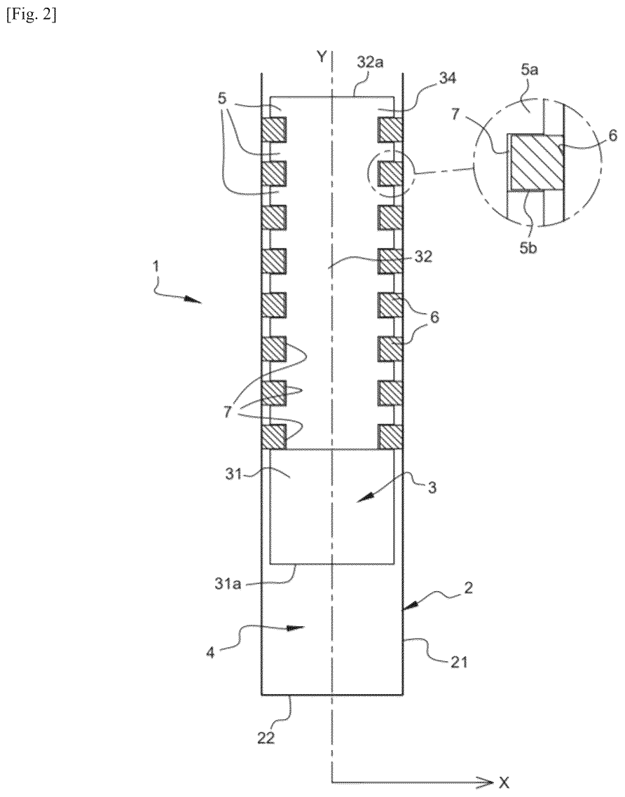

Advantageously, as illustrated in [FIG. 1], the system of crenelation(s) 5 may be produced separately from the piston 3. In an alternative form illustrated in [FIG. 2], the system of crenelation(s) 5 may form a single body with the piston 3.

When produced separately from the piston 3, the system of crenelation(s) 5 may be reversibly assembled thereto. For example, the system of crenelation(s) 5 may be removably threaded onto the piston 3, and more specifically along the lateral wall 34 of the shaft 32.

In the configuration in which it is removable with respect to the piston, the system of crenelation(s) 5 is configured to cooperate with the lateral wall 34 of the piston 3 with an interference fit and in a sealed manner. Such an interference fit is achieved by differential thermal contraction of the system of crenelation(s) 5 with respect to the piston 3.

It is to be noted that the interference fit and/or the sealing between the system of crenelation(s) and the piston 3 can be achieved exclusively by the differential thermal contraction of the system of crenelation(s) with respect to the piston 3.

The system of crenelation(s) 5 projects radially with respect to the lateral wall 34 of the piston 3. Thus, the system of crenelation(s) 5 delimits a set of groove(s), i.e. a set of recess(es) or hollow(s), configured to receive a set of gasket seal(s) 6.

The set of gasket seal(s) 6 is configured to cooperate with the liner 2 to limit a flow of fluid outside the expansion and/or compression chamber 4.

The expression “system of crenelation(s) 5” (and/or set of groove(s) or set of gasket seal(s) 6) refers to a system comprising one or more crenelations 5 (or a set comprising one or more grooves, or a set comprising one or more gasket seals 6 respectively).

In the example illustrated in [FIG. 1] and [FIG. 2], the shoulder formed between the head 31 and the shaft 32 of the piston 3 cooperates with a first crenelation of the set of crenelation(s) 5 to form a first groove of the set of groove(s).

[FIG. 1] and [FIG. 2] each illustrate a machine comprising a plurality of crenelations, grooves and gasket seals, with an enlarged view of a groove which is delimited by a first crenelation 5a and a second crenelation 5b.

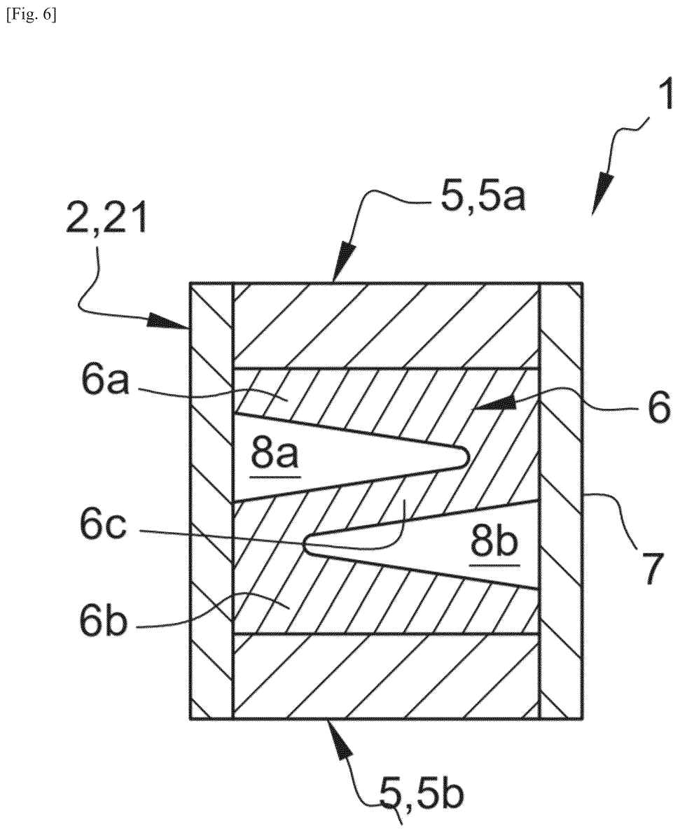

In a first embodiment illustrated in [FIG. 1] to [FIG. 6], each groove delimited by a first crenelation 5a and a second crenelation 5b is provided with a single gasket seal 6. In particular, [FIG. 1] and [FIG. 2] show a groove with a single gasket seal 6.

The gasket seal 6 has an outer lateral face configured to cooperate with the lateral wall 21 of the liner 2 with an interference fit. The gasket seal 6 also has an inner lateral face configured to face the lateral wall 34 of the piston 3. Lastly, the gasket seal 6 has a first transverse face and a second transverse face which extend between the outer lateral face and the inner lateral face.

In the example illustrated, the first transverse face of the seal 6 is arranged facing the first crenelation 5a. The second transverse face of the seal 6 is arranged facing the second crenelation 5b.

Moreover, the gasket seal 6 has a through-orifice allowing a stream of fluid to flow from the expansion and/or compression chamber 4 towards the second end 32a of the piston 3. The through-orifice extends between the first transverse face and the second transverse face of the gasket seal 6.

Advantageously, the machine comprises at least one expander 7 which is positioned between the gasket seal 6 and the shaft 32 of the piston 3. The at least one expander 7 is configured to press the gasket seal 6 radially (i.e. in the direction X) against the lateral wall 21 of the liner 2.

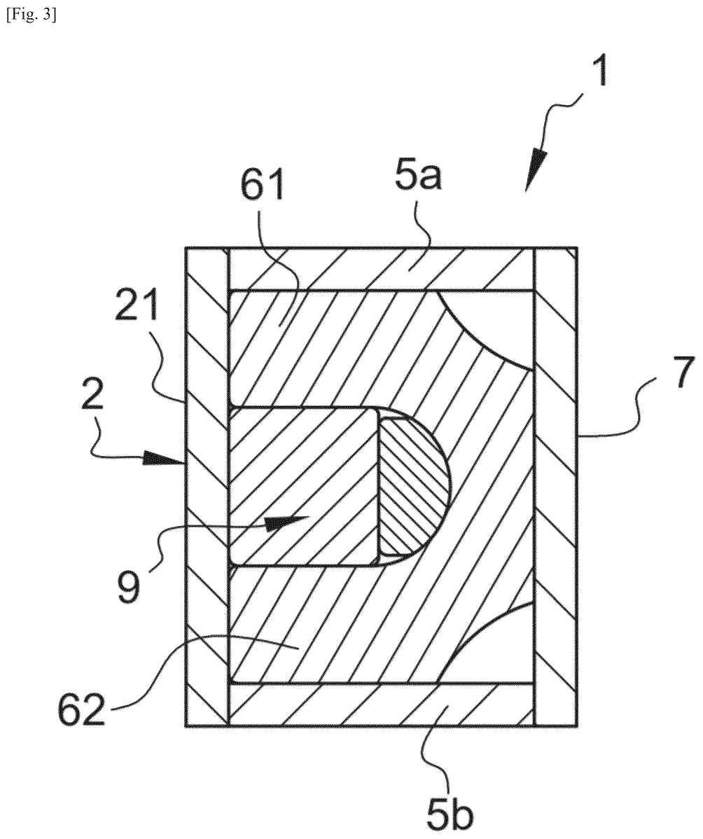

According to the invention, as illustrated in [FIG. 3] to [FIG. 6], the gasket seal 6 comprises at least one cavity 8 separate from the through-orifice. The cavity 8 is configured to accommodate a system 9 for pressing the gasket seal 6 in the main direction Y of the piston 3.

More specifically, the pressing system is configured to press, in the direction Y of the piston 3, the seal 6 against the first crenelation 5a and against the second crenelation 5b.

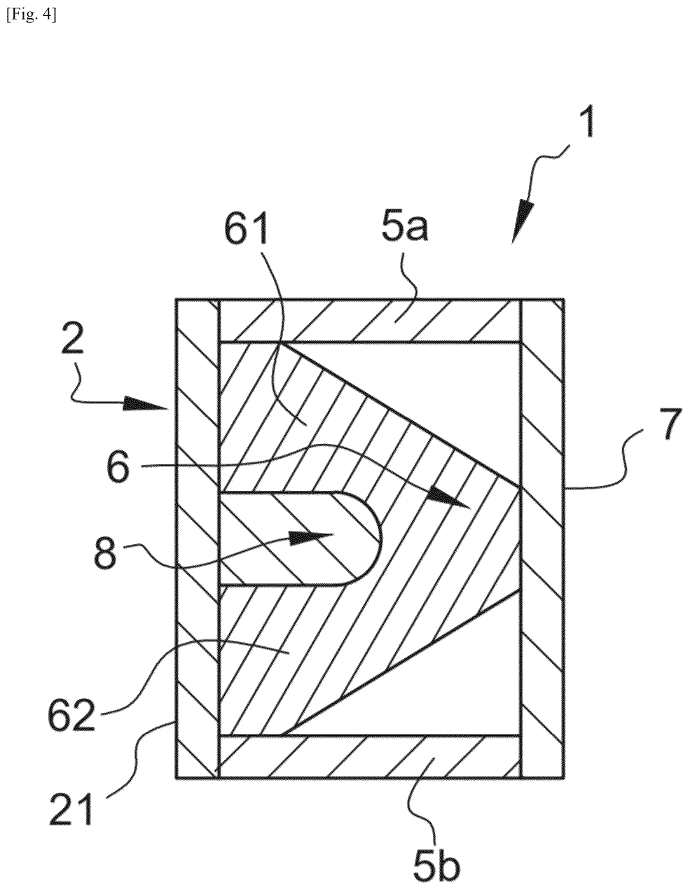

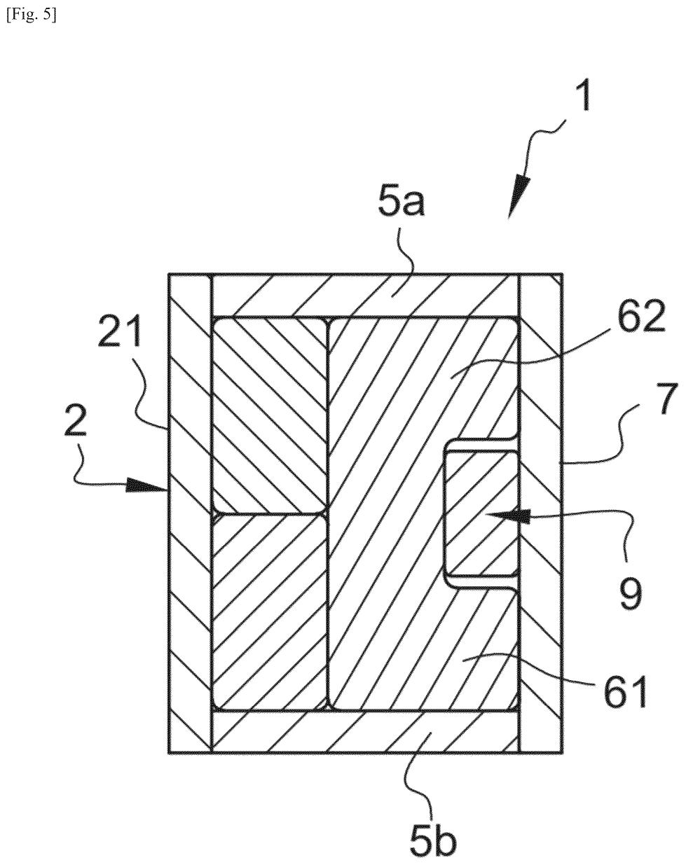

In the examples illustrated in [FIG. 3], [FIG. 4] and [FIG. 5], the gasket seal 6 has a C-shaped profile in a section in a longitudinal plane.

In this sectional plane, the gasket seal 6 comprises two lateral lips: a first lip 62 arranged facing the first crenelation 5a, and a second lip 61 arranged facing the second crenelation 5b. The lips 61, 62 define between them the cavity 8 configured to accommodate the pressing system 9.

Advantageously, the cavity 8 configured to accommodate the pressing system has an annular shape.

With reference to [FIG. 3] and [FIG. 4], the cavity 8 and the pressing system 9 face the liner 2. In [FIG. 4], the gasket seal 6 is illustrated without the pressing system 9.

With reference to [FIG. 5], the cavity 8 and the pressing system 9 face the piston 3, in contact with the expander 7.

In the example illustrated in [FIG. 6], the gasket seal 6 has a Z-shaped profile in a section in a longitudinal plane. The gasket seal 6 in that case comprises two horizontal branches 6a, 6b connected by an oblique branch 6c. The branches 6a, 6b, 6c delimit two cavities 8a, 8b, each intended to receive a pressing system.

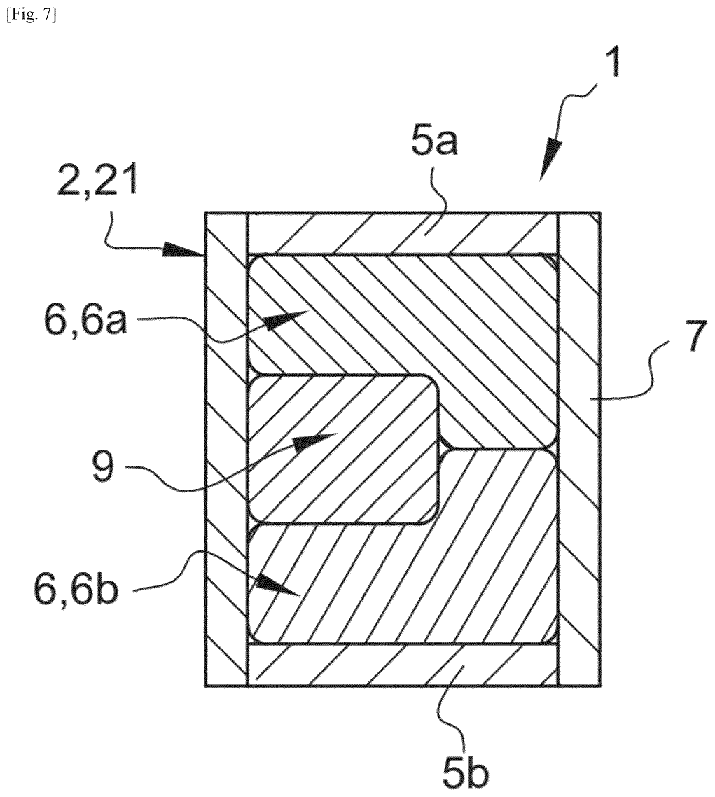

In a second embodiment illustrated in [FIG. 7] to [FIG. 11], each groove contains two separate gasket seals 6a, 6b which are arranged facing each other: a first seal 6a which is arranged facing the first crenelation 5a, and a second seal 6b which is arranged facing the second crenelation 5b.

More specifically, the first seal 6a has a first transverse face which is arranged facing the first crenelation 5a. The second seal 6b has a second transverse face which is arranged facing the second crenelation 5b.

In addition, the first seal 6a comprises a first through-orifice. The second seal comprises a second through-orifice. The two through-orifices are angularly offset from each other about the main direction Y of the machine 1. This angular offset between the through-orifices creates a leakage path which goes to the interface of the two seals 6a, 6b.

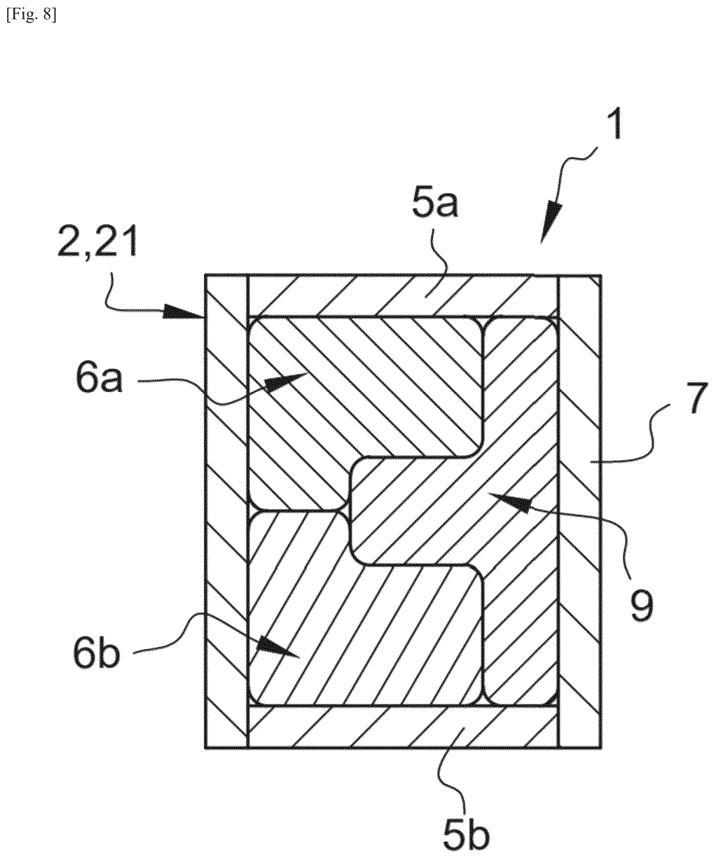

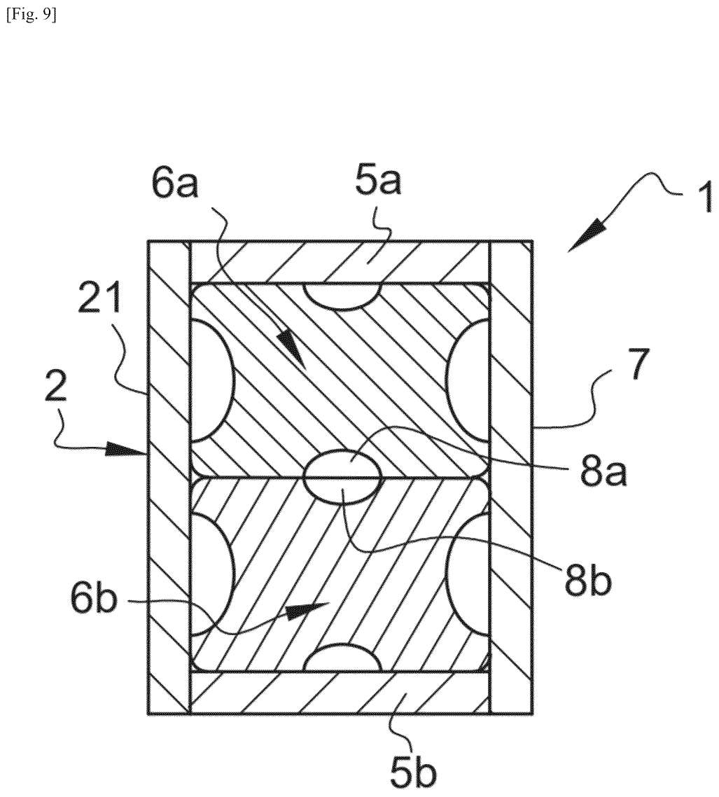

With reference to [FIG. 7], [FIG. 8] and [FIG. 9], the first seal 6a and the second seal 6b arranged in a common groove are provided with at least one first notch 8a and at least one second notch 8b, respectively. The notches 8a, 8b are visible in particular in [FIG. 9].

In particular, the notches 8a, 8b are formed respectively on the opposite transverse faces of the seals 6a, 6b. The notches 8a, 8b therefore face each other and form the cavity 8 configured to accommodate the pressing system 9.

It should be noted that in the example illustrated in [FIG. 9], the first seal 6a, and/or the second seal 6b, may also be provided with at least one additional notch formed on a lateral face of said seal 6a, 6b. The respective additional notches of the seals 6a, 6b are configured to accommodate a system for pressing said seals 6a, 6b in the radial direction X.

In this second embodiment, the cavity 8 (and consequently the pressing system 9) may occupy a position close to the lateral wall 21 of the liner 2 (see [FIG. 7]), or a position close to the lateral wall 34 of the piston 3 (see [FIG. 8]), or else a middle position, substantially equidistant between the lateral wall 21 of the liner 2 and the lateral wall 34 of the piston 3 (see [FIG. 9]).

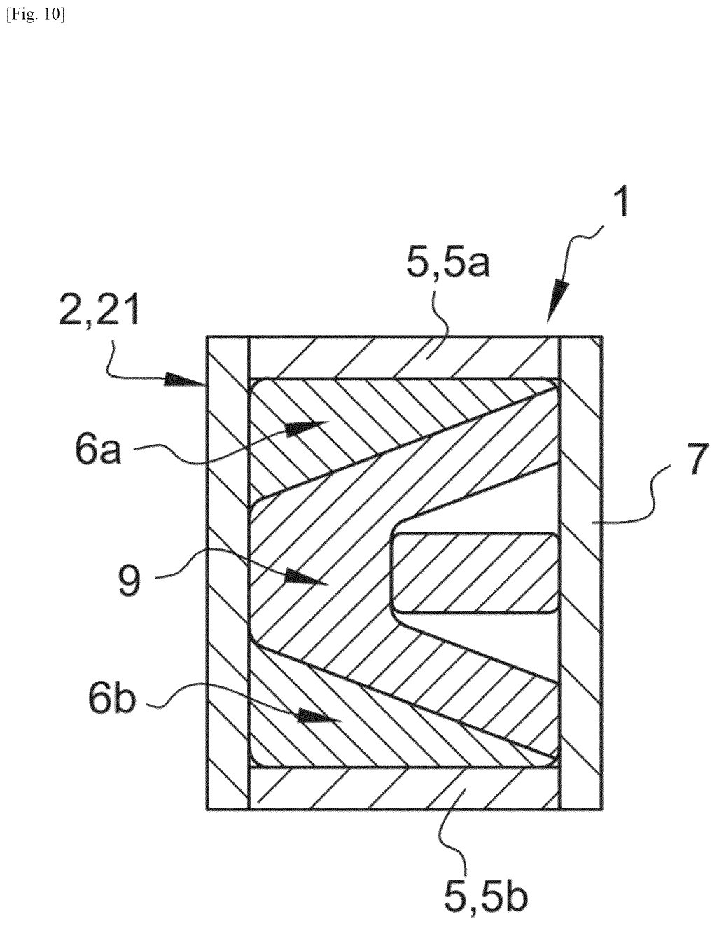

With reference to [FIG. 10] and [FIG. 11], the first seal 6a and the second seal 6b are positioned at a certain distance from each other. The first seal 6a and the second seal 6b form between them a gap which constitutes the cavity 8 configured to accommodate the pressing system 9.

In particular, in the example illustrated in [FIG. 11], the first seal 6a has a planar first transverse face arranged facing the first crenelation 5a and a convex second transverse face. The convex second face has a V-shaped profile in a longitudinal section of the machine 1.

The second seal 6b has a planar first transverse face arranged facing the second crenelation 5b and a concave second transverse face. The concave second face has a V-shaped profile in a longitudinal section of the machine 1.

Thus, the convex transverse face of the first seal 6a and the concave transverse face of the second seal 6b are arranged facing each other and have complementary geometries.

The pressing system 9 may consist of a mass of fluid which originates from the compression chamber 4 and is stored in the cavity 8.

In this case, the cavity 8 is in fluidic communication with the through-orifice of the seal 6 (or, in respect of the second embodiment, the through-orifices of the seals). This is the case for the machine illustrated in [FIG. 6] and [FIG. 9].

In the example illustrated in [FIG. 9], the mass of fluid stored in the cavity 8 presses the first seal 6a against the first crenelation 5a, and the second seal 6b against the second crenelation 5b. This pressing is performed in the main direction Y of the piston 3.

In an alternative form, the pressing system 9 may comprise a solid insert. This is the case for the machine illustrated in [FIG. 3] to [FIG. 5], [FIG. 7], [FIG. 8], [FIG. 10] and [FIG. 11].

In the examples illustrated in [FIG. 3] to [FIG. 5], the insert 9 presses the first lip 61 of the seal 6 against the first crenelation 5a, and the second lip 62 of the seal 6 against the second crenelation 5b. This pressing is performed in the main direction Y of the piston 3.

In the examples illustrated in [FIG. 7], [FIG. 8], [FIG. 10] and [FIG. 11], the insert 9 presses the first seal 6a against the first crenelation 5a, and the second seal 6b against the second crenelation 5b. This pressing is performed in the main direction Y of the piston 3.

The insert forming the pressing system is advantageously produced from a material different from that of the seals 6a, 6b. The coefficient of thermal expansion of the insert is greater than the coefficient of thermal expansion of the seals 6a, 6b.

It should be noted that the insert extends along the cavity 8 and may have different profiles in a longitudinal section of the machine 1.

In particular, with reference to [FIG. 3], [FIG. 4] and [FIG. 5], the insert 9 may have a rectangular profile which is complementary to the rectangular profile of the cavity 8. In this case, the insert 9 is arranged entirely in the cavity 8.

With reference to [FIG. 8], the insert 9 may have an inverted T-shaped profile in a longitudinal sectional plane of the machine 1. In this longitudinal sectional plane, the insert 9 therefore comprises two branches: a first branch which is arranged in the cavity 8, and a second branch which is arranged against the expander 7.

With reference to [FIG. 10], in a longitudinal sectional plane of the machine 1, the insert 9 may have a C-shaped profile which is complementary to the profile of the cavity 8 formed between the first seal 6a and the second seal 6b.

With reference to [FIG. 11], the insert 9 may have a V-shaped profile in a longitudinal sectional plane of the machine 1. This profile has a shape which is complementary to that of the profile of the first seal 6a and the second seal 6b.

Advantageously, the system of crenelation(s) 5 forms a first group of elements in which all the crenelations 5 are preferably substantially identical (in particular in terms of their physicochemical properties). Likewise, the set of gasket seal(s) 6 forms a second group of elements in which all the seals 6 are preferably substantially identical (in particular in terms of their physicochemical properties).

Advantageously, in its removable configuration, the system of crenelation(s) 5 is produced from a material different from the material of the piston 3.

Advantageously, the system of crenelation(s) 5 and/or the set of seal(s) 6 may be produced from polymer (based on PTFE, PEEK, PAEK, PA, PAI, PI, PPS, PPA). The piston 3 and/or the liner 2 may be produced from metal (for example steel, copper alloy, aluminium alloy, etc.).

Such a choice of materials makes it possible to limit the risk of heating between the system of crenelation(s) 5 and the piston 3 on the one hand, and between the set of seal(s) 6 and the liner 2 on the other.

Advantageously, the piston 3 and the liner 2 are metals and may have a coefficient of thermal expansion of between 5·10⁻⁶ m/(m·K) and 30·10⁻⁶ m/(m·K). The system of crenelation(s) 5 and the set of seals(s) 6 may be made of polymer. The material of the system of crenelation(s) 5 and/or the material of the set of seals(s) 6 may have a coefficient of thermal expansion greater than that of the material selected for the piston 3 and the liner 2.

Regardless of the material chosen for the piston 3, and regardless of the material chosen for the system of crenelation(s) 5, a sufficient difference between the respective coefficients of thermal expansion of these materials is necessary to ensure a differential contraction of the system of crenelation(s) with respect to the piston 3. Advantageously, this difference is at least 2·10⁻⁶ m/(m·K), and preferably between 2·10⁻⁶ and 3·10⁻⁶ m/(m·K).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A piston for a fluid machine,
the piston being configured to be mounted, at least in part, inside a liner of the fluid machine with a relative back- and forth movement with respect to the liner,
the piston extending in a main direction and comprising a head, which has a first end of the piston, and a shaft, which has a second end of the piston, the first end of the piston being configured to delimit, with the liner of the machine, a fluid expansion and/or compression chamber,
the shaft comprising a lateral wall which is provided with at least one annular groove defined between a first crenelation and a second crenelation,
the at least one annular groove being equipped with at least one gasket seal configured to cooperate in a sealed manner with a lateral wall of the liner of the machine,
the at least one gasket seal being provided with a through-orifice configured to allow a stream of fluid to flow from the expansion and/or compression chamber towards the second end of the piston,
wherein the at least one gasket seal comprises a cavity separate from the through-orifice, the cavity comprising a pressing system configured to press the gasket seal against the first crenelation and against the second crenelation, in the main direction of the piston, the pressing system being of a mechanical and/or fluidic type.

2. The piston according to claim 1, wherein the at least one gasket seal comprises, in a single piece, two lateral lips: a first lip arranged facing the first crenelation, and a second lip arranged facing the second crenelation, the lips of the seal defining between them the cavity configured to accommodate the pressing system.

3. The piston according to claim 1, wherein two separate gasket seals are arranged facing each other in the at least one groove: a first seal facing the first crenelation and a second seal facing the second crenelation.

4. The piston according to claim 1, wherein the two seals have facing faces, each provided with a notch, the respective notches of the seals being aligned to form the cavity configured to accommodate the pressing system.

5. The piston according to claim 1, wherein the pressing system is in the form of an insert arranged permanently in the cavity, and/or comprises a mass of fluid which originates from the compression chamber and is stored in the cavity.

6. The piston according to claim 5, wherein the at least one gasket seal comprises, in a single piece, two lateral lips: a first lip arranged facing the first crenelation, and a second lip arranged facing the second crenelation, the lips of the seal defining between them the cavity configured to accommodate the pressing system, wherein the mass of fluid, or the insert, is configured to press, in the main direction of the piston, the first lip of the seal against the first crenelation and the second lip of the seal against the second crenelation.

7. The piston according to claim 5, wherein two separate gasket seals are arranged facing each other in the at least one groove: a first seal facing the first crenelation and a second seal facing the second crenelation, wherein the mass of fluid, respectively the insert, is configured to press, in the main direction of the piston, the first seal against the first crenelation and the second seal against the second crenelation.

8. The piston according to claim 5, wherein the insert and the at least one seal consist respectively of materials having different coefficients of thermal expansion, the coefficient of thermal expansion of the insert being greater than the coefficient of thermal expansion of the seal.

9. A cryogenic fluid machine comprising:
a liner and
a piston according to claim 1, the piston being inserted at least in part inside the liner so as to form, with the liner, a fluid expansion and/or compression chamber, the piston and the liner being configured so as to be movable one with respect to the other in a relative back- and-forth movement.

10. The cryogenic fluid machine as claimed in claim 9, wherein the cryogenic fluid machine is a pump.

11. The cryogenic fluid machine as claimed in claim 9, wherein the cryogenic fluid machine is a hydrogen pump.
